(19) United States
(12) Patent Application Publication
(10) Pub. No.: US 2026/0340030 A1
(43) Pub. Date: Oct. 29, 2026

(54) INFORMATION PROCESSING APPARATUS AND CONTROL METHOD THEREOF, IMAGE GENERATING APPARATUS, AND IMAGE CAPTURING APPARATUS

(71) Applicant: CANON KABUSHIKI KAISHA, Tokyo (JP)

(72) Inventors: KEI OCHIAI, Kanagawa (JP); MASATO AOBA, Tokyo (JP)

(21) Appl. No.: 19/556,975

(22) Filed: Mar. 4, 2026

(30) Foreign Application Priority Data
Mar. 7, 2025 (JP) 2025-036694

(51) Int. Cl. G06F 16/58; G06F 16/587

(52) U.S. Cl. CPC G06F 16/5866; G06F 16/587

(57) ABSTRACT

An information processing apparatus obtains captured image data; obtains date/time information and location information indicating a time that the captured image data was shot; obtains event information based on the date/time information and the location information; and generates a supervisory data set usable for machine learning of an AI model based on a plurality of pieces of image data associated with the event information that are obtained. The supervisory data set is to be generated by adding annotation data including ground truth to each of the plurality of pieces of image data.

### BACKGROUND

### Field of the Technology

The present disclosure relates to a generation technique of supervisory data used for machine learning.

### Description of the Related Art

In recent years, machine learning technology has been utilized in various fields. Among them, is “supervised learning” in which machine learning is performed based on supervisory data including correct answer data in order to generate an inference model is generated. In order to obtain an inference model with a highly generalized performance in supervised learning, various inputs determined by a task to be solved and supervisory data constituted by annotation data including high-quality ground truth (GT) data for them are required.

In general, in order to obtain high-quality supervisory data, it is necessary to use a public data set generated for the purpose of competition or the like. Alternatively, it is necessary for a user to generate a data set by a user himself/herself if there is no supervisory data suitable for the purpose. In order to generate a data set by the user himself/herself, it is necessary to perform grouping of the data and adding annotation data that is associated with the user's purpose. This results in work that requires specialized knowledge and effort. In order to reduce data grouping work, Japanese Patent Application Laid-Open No. 2014-11536 (Patent Document 1) proposes a method of searching for event information from date/time information and location information at the time of shooting image data, adding the event information to the image data, and performing grouping.

However, the technique described in Patent Document 1 only performs grouping of image data, and it is difficult to use as it is as supervisory data to be used for learning of a machine learning model. For example, in supervisory data, it is necessary to add annotation data to the image data. In particular, it is necessary to add more detailed annotation data to supervisory data used to perform learning suitable for the user's purpose.

### SUMMARY

The present disclosure provides a technique of generating a data set to be used for learning of an AI model.

An information processing apparatus comprises: one or more memories storing instructions; and one or more processors that, upon execution of the stored instructions, are configured to: obtain captured image data; obtain date/time information and location information indicating a time that the captured image data was shot; obtain event information based on the date/time information and the location information; and generate a supervisory data set usable for machine learning of an AI model based on a plurality of pieces of image data associated with the event information that are obtained, wherein the supervisory data set is to be generated by adding annotation data including ground truth to each of the plurality of pieces of image data.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view illustrating a hardware configuration of an information processing apparatus.

FIG. 2 is a block diagram illustrating a functional configuration of a client terminal.

FIG. 3 is a flowchart of data set generation.

FIG. 4 is a view illustrating an example of a GUI screen of a data set generation application.

FIG. 5 is a block diagram illustrating a functional configuration of a client terminal (Modification 1).

FIG. 6 is a view illustrating an example of a GUI screen of a data set generation application (Modification 1).

FIG. 7 is a block diagram illustrating a functional configuration of a client terminal (Modification 2).

FIG. 8 is a flowchart of data set generation (Modification 2).

FIG. 9 is a view illustrating an example of a GUI screen of a schedule management application.

FIG. 10 is a block diagram illustrating a functional configuration of a client terminal (second embodiment).

FIG. 11 is a block diagram illustrating a functional configuration of a client terminal (third embodiment).

FIG. 12 is a view illustrating an example of a GUI screen of a data set generation application (third embodiment).

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

As a first embodiment of the information processing apparatus according to the present disclosure, a client terminal that generates a data set to be used for learning of image generation AI (AI model) using captured image data will be described below as an example.

### Apparatus Configuration

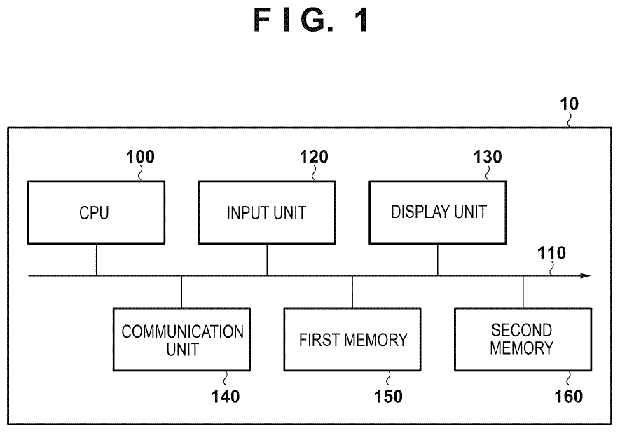

FIG. 1 is a view illustrating a hardware configuration of the information processing apparatus. An information processing apparatus 10 includes, as an example of a hardware configuration, a CPU 100, a bus 110, an input unit 120, a display unit 130, a communication unit 140, a first memory 150, and a second memory 160. The bus 110 mutually connects the respective units of the information processing apparatus 10.

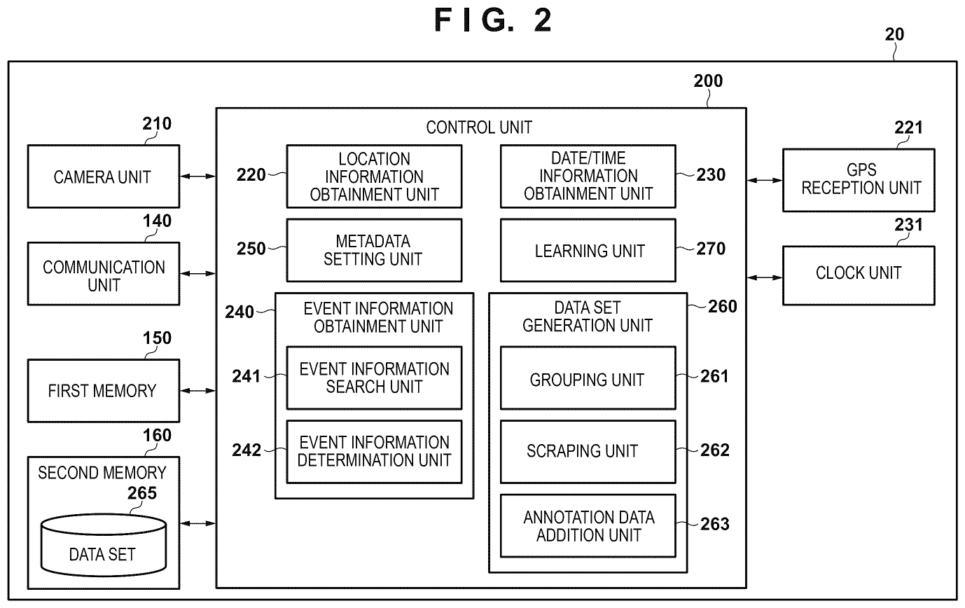

The CPU 100 is a central processing unit, and performs calculation and logical determination for various types of processing. Various programs are executed and predetermined processing (e.g., processing of a control unit 200 in FIG. 2) is performed. The input unit 120 is constituted by a keyboard, a touch panel, and the like, and receives input from the user. The display unit 130 is constituted by a liquid crystal display or the like, displays various types of data and processing results, and presents information to the user. The communication unit 140 communicates with another apparatus via a wired connection or a wireless connection. Note that an instruction from the user may be received from another apparatus via the communication unit 140, or a processing result may be output to another apparatus.

The first memory 150 and the second memory 160 are memories that store a control program for executing processing described later and various types of data. Here, it is assumed that the first memory 150 mainly stores a control program, and the second memory 160 mainly stores various types of data, but there is no particular limitation to this. The first memory 150 and the second memory 160 are constituted by a read only memory (ROM), a random access memory (RAM), a hard disk drive (HDD), and the like, but another storage apparatus having a similar role may be used.

FIG. 2 is a block diagram illustrating a functional configuration of the client terminal. A client terminal 20 is a terminal apparatus on which the user browses and operates a screen, and can be configured as, for example, a personal computer (PC), a smartphone, or a digital camera. The client terminal 20 includes a camera unit 210, the communication unit 140, the first memory 150, the second memory 160, the control unit 200, a GPS reception unit 221, and a clock unit 231. However, the client terminal 20 illustrated in FIG. 2 may be configured as one apparatus or may be configured as a system including a plurality of apparatuses. It is assumed that the client terminal 20 can access the Internet/Intranet or the like via the communication unit 140 and can be connected to a given search service or the like.

The camera unit 210 performs shooting and generates captured image data such as a still image or a moving image. Here, the client terminal 20 may be a camera-equipped terminal incorporating the camera unit 210, or may be connected to the camera unit 210 via the communication unit 140, thereby receiving a shot image.

The GPS reception unit 221 receives a GPS signal emitted from a GPS satellite and obtains geographical location information. The clock unit 231 manages date/time information (time) in the client terminal 20. Here, for example, the date/time information may be obtained using a network time protocol (NTP) via the communication unit 140, or may be obtained from a GPS signal received by the GPS reception unit 221.

The control unit 200 includes a location information obtainment unit 220, a date/time information obtainment unit 230, an event information obtainment unit 240, a metadata setting unit 250, a data set generation unit 260, and a learning unit 270. It is assumed that each function of the control unit 200 is implemented by software by the information processing apparatus 10 executing various programs. However, some or all of the functions may be implemented by hardware such as an application specific integrated circuit (ASIC).

The location information obtainment unit 220 obtains, via the GPS reception unit 221, location information at the time point when the camera unit 210 performs image shooting. The date/time information obtainment unit 230 obtains date/time information at the time point when the camera unit 210 performs image shooting. Here, the obtained location information and date/time information may be stored as data different from the image data, or may be stored as metadata associated with the image data. For example, Exchangeable image file format (Exif) can be used as metadata associated with the image data.

The event information obtainment unit 240 includes an event information search unit 241 and an event information determination unit 242, and obtains event information associated with an image based on location information and date/time information. The event information search unit 241 searches for corresponding event information via a network using location information and date/time information as keywords. The event information determination unit 242 performs processing to identify best-matching terms/phrases from the search results and obtains information of the event.

Here, the event information is, for example, the event name, each title name in the event, the start time of each title in the event, the main gender and race of participants in the event, whether the event is held outdoors or indoors, and the like, but is not limited to these.

The metadata setting unit 250 stores information regarding an image as metadata in association with the image. The metadata includes, for example, information items such as date/time information, location information, event information, and camera setting information, but is not limited to this. As described above, the metadata may be stored in the second memory 160 as the captured image data including the metadata, or may be stored as another piece of data that refers to the image.

The data set generation unit 260 includes a grouping unit 261, a scraping unit 262, and an annotation data addition unit 263, and generates a data set 265 based on event information. Although details will be described later, the data set 265 is generated by dividing (grouping) images into a plurality of groups based on the grouping item designated by the user and adding annotation data.

Note that the event information obtainment unit 240 and the metadata setting unit 250 may be configured to operate simultaneously with shooting of an image, or may operate automatically in a case where a predetermined condition is satisfied (e.g., in a case where the number of shot images or time exceeds a threshold). It may be configured to operate when an instruction of data set generation is explicitly indicated by the user.

The learning unit 270 performs machine learning using the data set 265 generated by the data set generation unit 260, and generates a machine learning model. Here, a model of image generation AI that generates a new image based on an input text or image is assumed as a machine learning model. However, the application to the image generation AI is merely an example, and can also be applied to models such as a scene recognition task, an object detection task, an image quality improvement task, and a translation task.

### Apparatus Operation

In the present embodiment, an example of generating a data set to be used for learning (additional learning) of image generation AI that generates a new image based on an input prompt (text or image) will be described. In particular, a form will be described in which event information related to an image of an automobile race shot by the user as a spectator is determined based on the image, image collection by scraping is performed based on the event information, and a data set is generated.

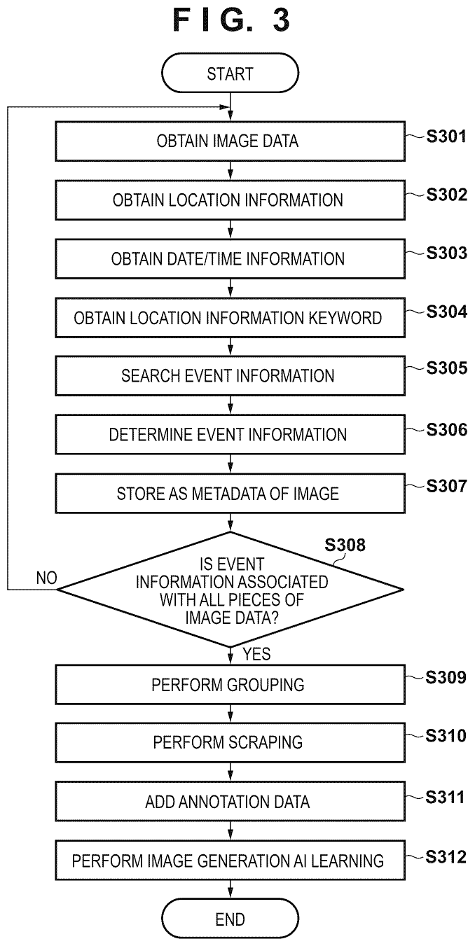

FIG. 3 is a flowchart of the data set generation. A plurality of pieces of image data shot by the user are stored in the second memory 160, those pieces of image data are subjected to the processing of S301 to S307, and event information is determined. A description will be given assuming that a supervisory data (training data) set is generated subsequently based on the event information of the image data selected by the user.

In S301, the control unit 200 obtains image data from the second memory 160. Here, it is assumed that image data of the automobile race (“Monaco Grand Prix”) shot by the user as a spectator is obtained.

In S302, the location information obtainment unit 220 obtains the location information at the time of shooting of the image data obtained in S301. Here, it is assumed that the location information obtainment unit 220 obtains “longitude 43.74, latitude 7.43” from the GPS signal received by the GPS reception unit 221 at the time of shooting of the image.

In S303, the date/time information obtainment unit 230 obtains the shooting date/time of the image data obtained in S301. Here, it is assumed that the date/time information obtainment unit 230 obtains “date/time: May 26, 1:30 PM”, which is information of the clock unit 231 at the time of shooting of the image.

In S304, the event information obtainment unit 240 determines a location information keyword based on the longitude/latitude information obtained as location information. The location information keyword is information (character string) related to the location information such as an address and a facility name, which is determined from the longitude/latitude information. For example, the longitude/latitude information is searched via the network, and an address and a corresponding facility name are determined and obtained as a location information keyword. Here, for example, “longitude 43.739, latitude 7.428” is determined to be “Monaco” as the location information keyword.

In S305, the event information search unit 241 searches for the corresponding event information via the network based on the date/time information obtained in S303 and the location information keyword obtained in S304. The event information is information (character string) regarding an event held at the place on the date/time. For example, the search may be performed using a general search engine on the Internet, or the search may be performed using generative AI (large-scale language model). Note that the search may be performed using the longitude/latitude information obtained in S302 in place of the location information keyword.

Here, it is assumed that a result of searching a search engine for “Monaco May 26 1:30 PM” is obtained. In this manner, the event information related to the image data obtained in S301 can be searched by date/time information and location information keyword.

In S306, the event information determination unit 242 determines, as event information, one or more character strings having an occurrence frequency higher than a threshold from the search result obtained by the event information search unit 241. Examples of the item of the event information include an event name, a competition name, and a main subject, and a plurality of items are associated with image data. Here, “event name: Monaco Grand Prix”, “competition name: F1”, “main subject: automobile”, and the like are determined as the event information and are associated with the image data.

In S307, the metadata setting unit 250 associates the event information with the image data. Here, the event information is added in the form of, for example, “event name: Monaco Grand Prix”, “competition name: F1”, and the like in the same manner as the information described in Exif such as “date/time: May 26 1:30 PM”.

In S308, the metadata setting unit 250 determines whether or not the event information is associated with all pieces of the image data to be processed that are stored in the second memory 160. In a case where it is determined that the event information is associated with all pieces of the image data, the processing proceeds to the data set generation processing of S309 to S311. In a case where it is determined that unprocessed image data remains, the processing returns to S301, and the same processing as described above is performed on the remaining image data. Note that it may be configured such that “whether or not the number of images associated with the event information has reached a certain number” or “whether or not the number of images associated with the same event information has reached a certain number” is determined in S308.

In S309 to S311, the data set generation unit 260 generates the data set 265 of machine learning including supervisory data (training data) based on the image data and the event information associated with the image. Data set shaping includes, for example, addition of annotation data and processing of data, but is not limited to this.

Here, the data set generation unit 260 is constituted by the grouping unit 261, the scraping unit 262, and the annotation data addition unit 263. An example in which images are grouped based on the grouping item designated by the user, annotation data is automatically added, and the number of images is expanded to obtain the data set 265 will be described.

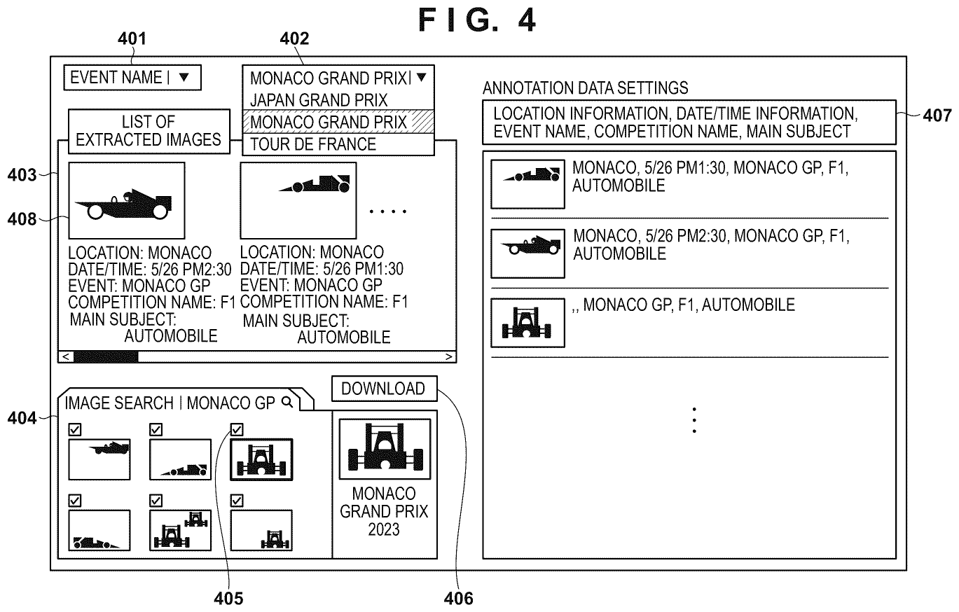

FIG. 4 is a view illustrating an example of the GUI screen of the data set generation application. A GUI screen is displayed on the client terminal 20 in association with the processing of S309 to S311.

In S309, the grouping unit 261 groups the images based on the grouping item designated by the user. In FIG. 4, setting windows 401 and 402 are select boxes for setting grouping items. The setting window 401 displays the type of event information, and “event name” is selected as the type. A list of event names is selectably displayed on the setting window 402, and here, “Monaco Grand Prix” is selected by the user. From the two settings, “event name: Monaco Grand Prix” is set as a grouping item, and a plurality of pieces of image data with which the grouping item is associated are grouped.

A display area 403 is an area for displaying a plurality of grouped images, and displays, as thumbnails in the area, an image of image data associated with “event name: Monaco Grand Prix” and information associated with the image. This enables the data set to be efficiently confirmed by removing images associated with different event information and displaying only images suitable for the user's purpose.

In S310, the scraping unit 262 scrapes (extracts) images associated with the same grouping item via the network via the communication unit 140, and expands the number of images included in the data set. Here, in the image scraping, scraping may be performed on the Internet, or scraping may be performed on a given image database (DB) or the like externally connected to the client terminal 20. The image to be obtained by the scraping is not limited to a captured image, and may include an image generated by image generation AI.

In FIG. 4, an image search tab 404 indicates a result of scraping an image with “Monaco Grand Prix” as a keyword from the Internet. A check box 405 is in a checked state in the initial state, and the checked image is downloaded when a download button 406 is pressed. In a case where there is an image not suitable for the user's purpose, the user can select whether or not to download the image by canceling the corresponding check. A large amount of images are required for the data set of the image generation AI, and this makes it possible to collect a large amount of images suitable for the user's purpose based on the event information.

In S311, the data set generation unit 260 adds annotation data to the image data. In the learning of the image generation AI using descriptive text as input, it is necessary to learn the relevance between the image and the descriptive text as supervisory data (training data). Therefore, the user is caused to input, to a setting window 407, information associated with the image, such as date/time information, location information, and competition information.

In FIG. 4, the setting window 407 is a text box for inputting the format of the text to be annotation data of the image generation AI. The annotation data is added to the image by creating a single text from the information corresponding to the item input in the text box. Here, for example,
as a text corresponding to
“location information, date/time information, event name, competition name, main subject”,
“Monaco, May 26 1:30 PM, Monaco Grand Prix, F1, automobile” is added as annotation data.

In S312, the learning unit 270 performs learning (additional learning) of the image generation AI using the data set 265 generated by the data set generation unit 260. That is, the user can obtain the image generation AI suitable for his/her purpose (“Monaco Grand Prix”-like image generation). Note that the data set 265 may be used to train a machine learning model, or may be used as verification data, evaluation data, or the like for measuring performance.

As described above, according to the first embodiment, the event information is determined based on the information at the time of shooting of the image data, and the plurality of pieces of image data related to the determined event information are included in the data set. At this time, information at the time of shooting and event information are added to the image data as annotation data. By performing learning of the image generation AI using the data set generated in this manner, the image generation AI suitable for the user's purpose is generated. That is, it is possible to generate a data set for obtaining the image generation AI suitable for the user's purpose. By performing scraping, a large amount of image data necessary for learning can be included in the data set.

### Modification 1

In Modification 1, a method of grouping images based on the similarity between pieces of event information will be described.

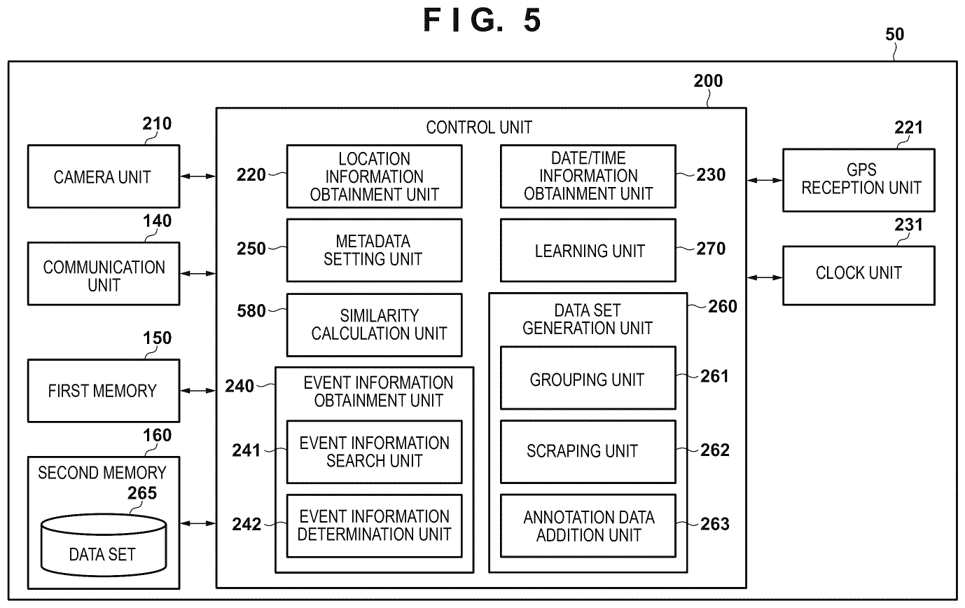

FIG. 5 is a block diagram illustrating a functional configuration of the client terminal in Modification 1. Unless otherwise specified, a client terminal 50 includes the configuration of the client terminal 20 (FIG. 2), and functional units having identical names execute similar operations.

A similarity calculation unit 580 calculates the similarity between pieces of event information for the plurality of pieces of image data stored in the second memory 160. In the calculation of the similarity, for example, the similarity may be calculated using a commonality of the event information such as the location information and the competition name. By converting keywords such as the event names into word vectors, the similarity between the word vectors may be calculated. Here, an example will be given in which an event name is input as a keyword and a list of image data associated with event names having high similarities between word vectors is displayed.

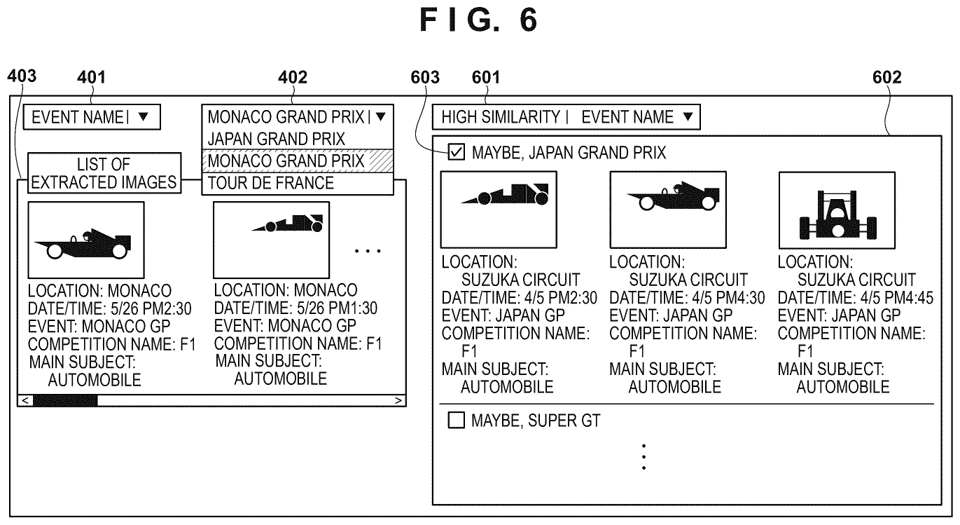

FIG. 6 is a view illustrating an example of the GUI screen of the data set generation application in Modification 1. Unless otherwise specified, UI components with the same reference numerals as in FIG. 4 have similar functions.

A setting window 601 is a select box for setting an item for calculating similarity. Here, the same content as that of the setting window 401 for grouping items is set as an option, and here, “event name” is selected as a similarity calculation item.

A display area 602 is an area in which images associated with event information with high similarity are grouped and displayed. Here, an image associated with “event name” having a high similarity to “event name: Monaco Grand Prix” existing in the second memory 160 and information associated with the image are displayed as thumbnails. In FIG. 6, “event names” associated with the images in the second memory 160 are displayed in descending order of similarity.

When the image associated with “event name” having high similarity is suited to the user's purpose, the user checks a check box 603. This can explicitly indicate that a corresponding image is to be included in the data set.

As described above, according to Modification 1, it is possible to generate a data set including image data having high relevance to the user's purpose.

### Modification 2

In Modification 2, a method of obtaining event information with reference to schedule information of the user will be described.

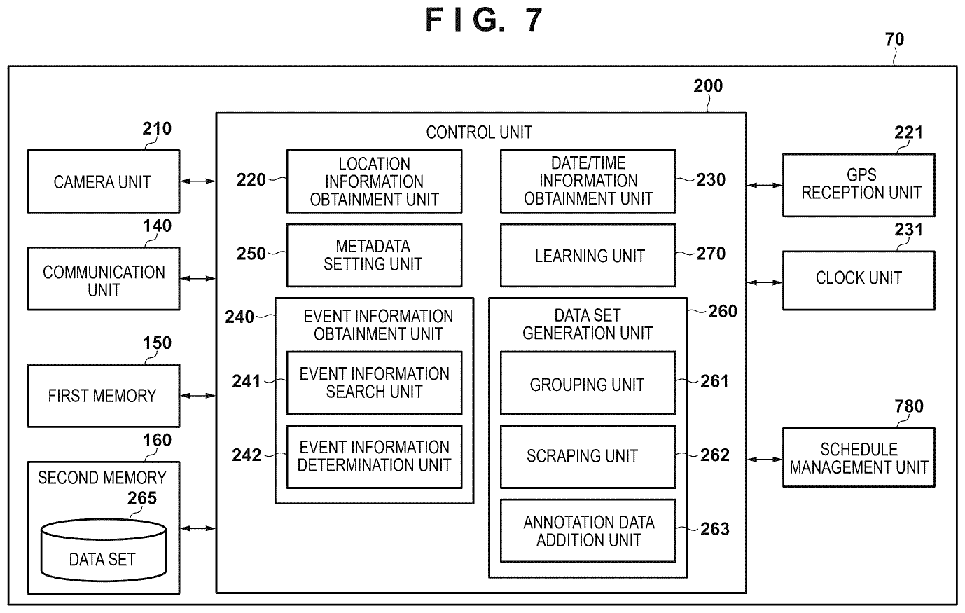

FIG. 7 is a block diagram illustrating a functional configuration of the client terminal in Modification 2. Unless otherwise specified, a client terminal 70 includes the configuration of the client terminal 20 (FIG. 2), and functional units having identical names execute similar operations.

A schedule management unit 780 manages schedule information of the user by associating event information with location information and date/time information. For example, it is implemented as a schedule management application or a calendar application.

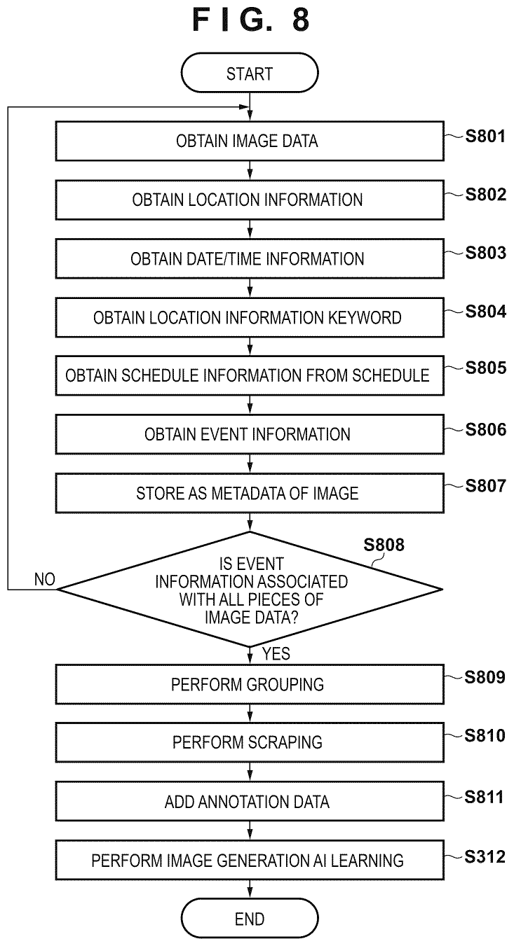

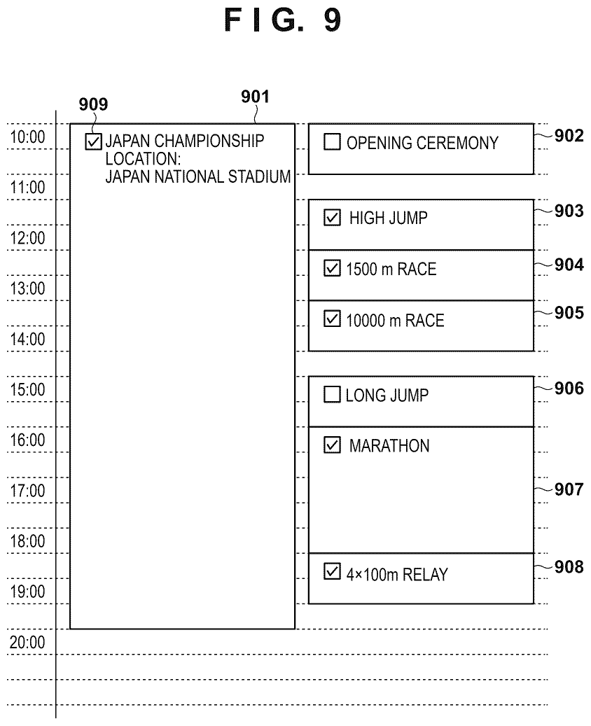

FIG. 8 is a flowchart of the data set generation in Modification 2. Note that S801 to S804 and S807 to S811 are similar to S301 to S304 and S307 to S311, respectively, and thus description thereof will be omitted. FIG. 9 is a view illustrating an example of the GUI screen of the schedule management application.

Here, FIG. 9 illustrates an application screen of the schedule management application displayed on the client terminal 70, and illustrates, as an example, the schedule information of the day on which the user participated in “Japan Championship”.

In FIG. 9, event boxes 901 to 908 are boxes associated with respective pieces of event information. The respective pieces of event information may be those in which the user inputs an event name, date/time information, and location information in advance, or may be those in which event information obtained via the network is automatically reflected.

Here, the event box 901 is associated with “event name: Japan Championship”, “location: Japan National Stadium”, and “date/time: 10 AM to 8 PM”. The event box 902 is associated with “event name: opening ceremony” as a detailed schedule of “Japan Championship.” The event boxes 903 to 908 are also associated with corresponding detailed schedules.

The check box 909 is a check box indicating whether the user has participated in the event. Here, regarding the input of the check, whether or not the user has participated may be manually input, or the check may be automatically input based on the information obtained by the location information obtainment unit 220 and the date/time information obtainment unit 230.

In S805, the event information search unit 241 queries the schedule management unit 780 for the schedule information using the date/time information and the location information (or the location information keyword) as inputs. For example, when there is an image associated with “date/time: 2 PM” and “location: Japan National Stadium”, schedule information such as “event: Japan Championship” and “competition: 10000-meter race” is obtained from the event box 905. On the other hand, the image associated with “date/time: 3 PM” and “location: Japan National Stadium” indicates, from the event box 906, that the user has not participated in “long jump”, and therefore the schedule information is not associated.

In S806, the event information search unit 241 searches, via the network, for event information based on the schedule information. For example, detailed information such as “race order” and “participants” of the corresponding event information can be obtained by searching “Japan Championship 10000-meter race 2 PM Japan National Stadium”.

As described above, according to Modification 2, the event information in which the user has participated can be determined in more detail/more accurately.

### Second Embodiment

In the second embodiment, a method of obtaining a learned model based on event information and generating a data set using the learned model will be described.

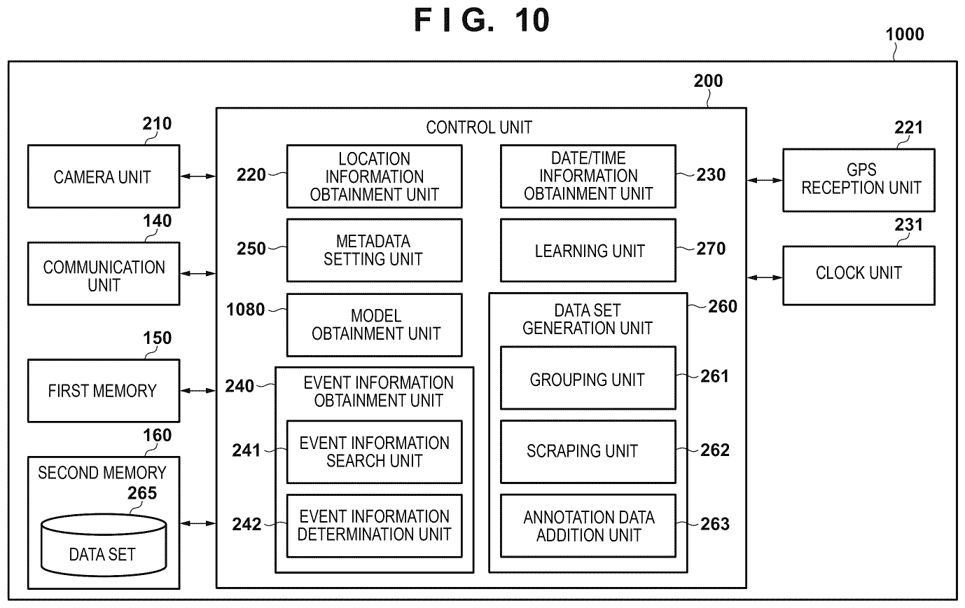

FIG. 10 is a block diagram illustrating a functional configuration of the client terminal in the second embodiment. Unless otherwise specified, a client terminal 1000 includes the configuration of the client terminal 20 (FIG. 2), and functional units having identical names execute similar operations.

The annotation data addition unit 263 adds a descriptive text to an image using a learned model obtained by a model obtainment unit 1080 described later. Specifically, the descriptive text is added to each of the images grouped by the grouping unit 261 and the images scraped by the scraping unit 262.

For example, based on an input image, detailed annotation data is added using a model (scene recognition model) that analyzes the content of the image. The scene recognition model outputs, as a descriptive text, for example, detection of an object, a category of a scene (indoors, outdoors, city, and the like), and a specific activity (driving, collision, and the like). As the scene recognition model, for example, a technique disclosed in Document A below can be used.

(Document A) Jiahui Yu et al., “CoCa: Contrastive Captioners are Image-Text Foundation Models”, arXiv: 2205.01917, May 2022

The model obtainment unit 1080 obtains a learned scene recognition model appropriate for annotation data addition via the network based on the grouping item set in the grouping unit 261. Note that the model may be selected (obtained) based on the matching rate between the grouping item and the tag associated with the learned scene recognition model.

The content of the image is analyzed using the obtained learned scene recognition model, and an analysis result (descriptive text) is obtained. For example, by inputting the date/time information, the location information, and the analysis result, the image generation AI can specifically learn the user's purpose. Here, for example, in an image 408 of FIG. 4,
as a text corresponding to
“location information, date/time information, event name, scene analysis result”,
“Monaco, May 26 1:30 PM, Monaco Grand Prix, black F1 car in motion with driver on board”
is added as annotation data.

As described above, according to the second embodiment, it is possible to add detailed annotation data to image data by using the scene recognition model. In particular, by selecting the scene recognition model based on the set grouping item, it is possible to add more accurate annotation data.

### Modification 3

In Modification 3, a method of extracting an image more suitable for the user's purpose from grouped images and scraped images using a learned model will be described.

In a case where grouping or scraping of images is performed using date/time information and location information as inputs, there is a case where the content of the image is not suitable for the user's purpose (although the date/time information and the location information are associated). For example, there is a case where an image in which a landscape or a person irrelevant to the user's purpose “event name: Monaco Grand Prix” is shot is obtained.

Therefore, the content of the image is analyzed using a learned scene recognition model, and the similarity between the event information and the scene analysis result is calculated using the similarity calculation unit 580. Here, the similarity between the word vectors of the event name associated with the image and the scene analysis result is calculated, and an image having a similarity of a threshold or more is extracted from the data set. This can more accurately extract an image more suitable for the user's purpose.

### Third Embodiment

In the third embodiment, a method of extracting an image using information on a machine learning model used at the time of shooting of the image will be described. Hereinafter, an example in which shooting is performed using an automobile detection model that detects the position of an automobile in an image will be described. However, the object detection model for detecting an automobile is merely an example, and does not limit the present disclosure.

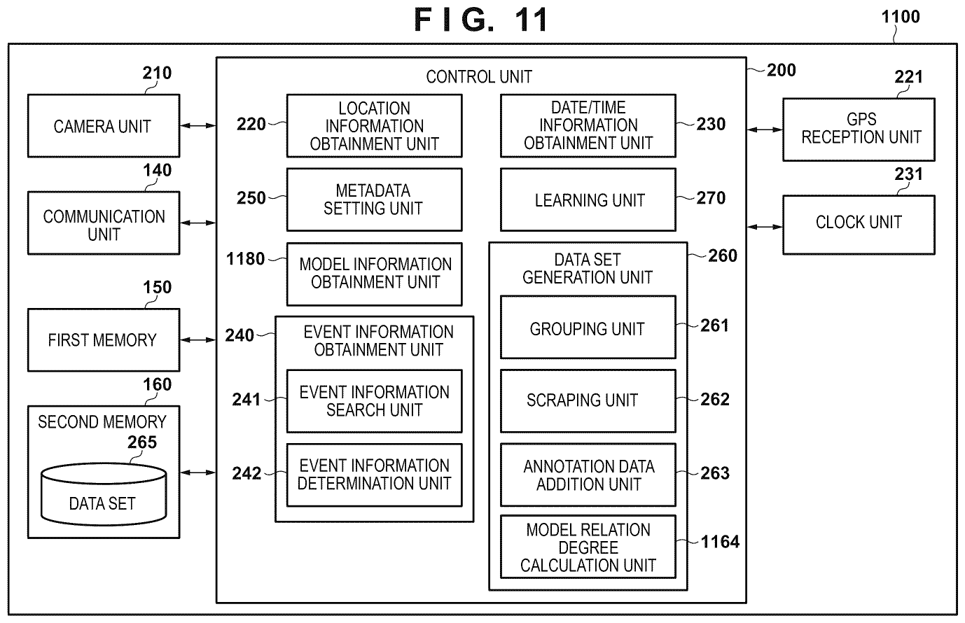

FIG. 11 is a block diagram illustrating a functional configuration of the client terminal in the third embodiment. Unless otherwise specified, a client terminal 1100 includes the configuration of the client terminal 20 (FIG. 2), and functional units having identical names execute similar operations.

A model information obtainment unit 1180 obtains usage information of the model at the time of image shooting in the camera unit 210. As the usage information of the model, for example, when the automobile detection model is used at the time of image shooting, the type of the detection model, the detection model name, information on whether or not a subject has been detected, and the like are obtained. Here, description will be given assuming that “detection model: automobile detection model”, “detection success?: yes”, and the like are added to an image shot in an automobile race (Monaco Grand Prix).

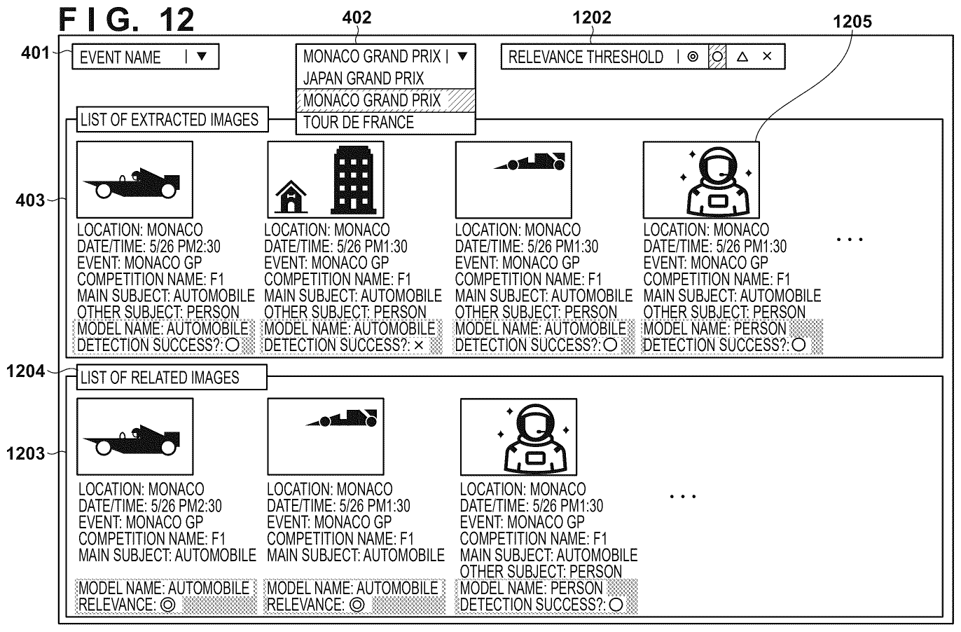

FIG. 12 is a view illustrating an example of the GUI screen of the data set generation application in the third embodiment. Unless otherwise specified, UI components with the same reference numerals as in FIG. 4 have similar functions.

The display area 403 displays, as thumbnails, an image associated with “event name: Monaco Grand Prix” and information associated with the image. Here, the information associated with the image includes shooting time model information 1204. As the information obtained by the model information obtainment unit 1180, the shooting time model information 1204 includes, for example, “model name: automobile” and information on whether the automobile has been successfully detected “detection success?: ○”.

A model relevance calculation unit 1164 calculates the relevance between the event information and the automobile detection model. For example, in a case where “main subject: automobile” is associated as the event information, and “detection success?: ○” is associated in the model information, “relevance: ⊚” is calculated. On the other hand, in a case where “main subject: automobile” is associated as the event information, and “detection success?: ×” is associated in the model information, “relevance: ×” is calculated.

Note that the model at the time of shooting is not limited to the automobile detection model, and for example, the automobile race may be shot using a person detection model. For example, in an image 1205, shooting is performed using the person detection model and, in a case where “main subject: automobile”, “other subject: person”, and “detection success?: ○”, “relevance: ○” is calculated. Note that here, the relevance is indicated in three stages of “⊚”, “○”, and “×”, but is not limited to the relevance in three stages.

A setting window 1202 is a select box for setting a threshold of the relevance extracted as a data set. In FIG. 12, “threshold: ○” is selected, and an image of “relevance: ○” or more (i.e., “⊚” or “○”) is finally extracted as a data set. The extracted image is displayed as a thumbnail in a display area 1203.

The user can obtain (generate) an object detection model suitable for the purpose by performing learning of the object detection model at the learning unit 270 with the data set 265 generated by the above processing. Note that the generated object detection model may be mounted on a camera and used for shooting (e.g., autofocus). The generated object detection model may be used to add annotation data by the annotation data addition unit 263.

As described above, according to the third embodiment, it is possible to generate a data set suitable for the user's purpose by extracting an image related to the model used at the time of shooting of the image data.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-036694, filed Mar. 7, 2025, which is hereby incorporated by reference herein in its entirety.

What is claimed is:

1. An information processing apparatus comprising:
one or more memories storing instructions; and
one or more processors that, upon execution of the stored instructions, are configured to:
obtain captured image data;
obtain date/time information and location information indicating a time that the captured image data was shot;
obtain event information based on the date/time information and the location information; and
generate a supervisory data set usable for machine learning of an AI model based on a plurality of pieces of image data associated with the event information that are obtained, wherein
the supervisory data set is to be generated by adding annotation data including ground truth to each of the plurality of pieces of image data.

2. The information processing apparatus according to claim 1, wherein execution of the stored instructions further configures the one or more processors to:
obtain the event information by inputting the date/time information and the location information to a given search unit.

3. The information processing apparatus according to claim 2, wherein execution of the stored instructions further configures the one or more processors to:
determine, as the event information, a character string having an occurrence frequency higher than a threshold among character strings included in a search result by the given search unit.

4. The information processing apparatus according to claim 1, wherein execution of the stored instructions further configures the one or more processors to:
set the event information as metadata of image data.

5. The information processing apparatus according to claim 1, wherein execution of the stored instructions further configures the one or more processors to:
divide the plurality of pieces of image data into a plurality of groups based on a designated grouping item.

6. The information processing apparatus according to claim 1, wherein execution of the stored instructions further configures the one or more processors to:
obtain the plurality of pieces of image data from a given image database based on the event information.

7. The information processing apparatus according to claim 5, wherein execution of the stored instructions further configures the one or more processors to:
obtain a plurality of pieces of captured image data,
obtain event information for each of the plurality of pieces of captured image data, and
calculate a similarity between pieces of event information for each of the plurality of pieces of captured image data, and divides the plurality of pieces of captured image data into a plurality of groups based on the similarity.

8. The information processing apparatus according to claim 1, wherein execution of the stored instructions further configures the one or more processors to:
manage a plurality of pieces of event information each associated with date/time information and location information, wherein
the event information is to be obtained by inputting the date/time information and the location information.

9. The information processing apparatus according to claim 1, wherein execution of the stored instructions further configures the one or more processors to:
obtain a learned model for performing scene analysis on image data related to the event information, wherein
an analysis result by the learned model for the plurality of pieces of image data is to be added as the annotation data.

10. The information processing apparatus according to claim 1, wherein execution of the stored instructions further configures the one or more processors to:
obtain model information of a learned model used at a time of shooting the captured image data; and
calculate a relevance between the event information and the model information, wherein
the supervisory data set is to be generated using one or more pieces of image data items having a relevance of a predetermined threshold or more among the plurality of pieces of image data.

11. The information processing apparatus according to claim 1, wherein execution of the stored instructions further configures the one or more processors to:
perform machine learning of the AI model using the supervisory data set.

12. An image generating apparatus comprising:
one or more memories storing instructions; and
one or more processors that, upon execution of the stored instructions, are configured to:
perform inference using an AI model subjected to machine learning by the information processing apparatus according to claim 11 and generates an image.

13. An image capturing apparatus comprising:
one or more memories storing instructions; and
one or more processors that, upon execution of the stored instructions, are configured to:
perform inference using an AI model subjected to machine learning by the information processing apparatus according to claim 11 and controls shooting.

14. A control method of an information processing apparatus, the control method comprising:
obtaining captured image data;
obtaining date/time information and location information indicating a time that the captured image data was shot;
obtaining event information based on the date/time information and the location information; and
generating a supervisory data set usable for machine learning of an AI model based on a plurality of pieces of image data associated with the event information that are obtained, wherein
in the obtaining and generating, the supervisory data set is generated by adding annotation data including ground truth to each of the plurality of pieces of image data.

15. A non-transitory computer-readable recording medium storing a program that, when executed by a computer, causes the computer to perform a control method of an information processing apparatus, the control method comprising:
obtaining captured image data;
obtaining date/time information and location information indicating a time that the captured image data was shot;
obtaining event information based on the date/time information and the location information; and
generating a supervisory data set usable for machine learning of an AI model obtaining a plurality of pieces of image data associated with the event information that are obtained, wherein
in the obtaining and generating, the supervisory data set is generated by adding annotation data including ground truth to each of the plurality of pieces of image data.
